(19) United States
(12) Patent Application Publication
(10) Pub. No.: US 2010/0133829 A1
(43) Pub. Date: Jun. 3, 2010

(54) IMPROVEMENTS IN OR RELATING TO WIND TURBINES

(75) Inventor: Tamas BERTENYI, Cambridge (GB)

Correspondence Address: SMITH, GAMBRELL & RUSSELL, 1130 CONNECTICUT AVENUE, N.W., SUITE 1130, WASHINGTON, DC, 20036, US

(73) Assignee: QUIET REVOLUTION LIMITED, LONDON (GB)

(21) Appl. No.: 12/594,150

(22) PCT Filed: Apr. 1, 2008
(86) PCT No.: PCT/GB2008/001151

§ 371 Date: Sep. 30, 2009

(30) Foreign Application Priority Data
Apr. 2, 2007 (GB) 0706416.5

(51) Int. Cl. F03D 7/06

(52) U.S. Cl. 290/44

(57) ABSTRACT

A wind turbine system comprising: a wind turbine; a regenerative drive system; a wind-speed sensor for measuring local wind speed; and a controller; the wind turbine comprising a motor-generator system which is operatively connected to the regenerative-drive system; the motor-generator system being drivable as a motor by the regenerative drive system to increase a rotational speed of the wind turbine; the motor-generator system being operable as a generator by the regenerative drive system to decrease a rotational speed of the wind turbine; the controller being operatively connected to the wind-speed sensor and the regenerative drive system, wherein the controller is operable to control operation of the regenerative-drive system to thereby control the rotational speed of the wind turbine in response to signals received from the wind sensor indicative of gusting changes in the local wind speed.

The present invention relates to improvements in wind turbines and in particular to a system for optimizing the energy converted from a wind turbine situated in a gusty wind environment.

Wind turbines are well known for their ability to convert wind energy into electrical energy. In order to increase the energy output of wind turbines the general practice has been to increase the swept area of the turbine by increasing the overall size of the turbine and or to situate the turbines in locations where strong mean wind speeds are experienced. However, these strategies are inappropriate for trying to optimize the energy output of turbines which, due to their location, may be limited in overall size or may experience turbulent, that is gusty, wind conditions. For example, turbines situated in urban environments.

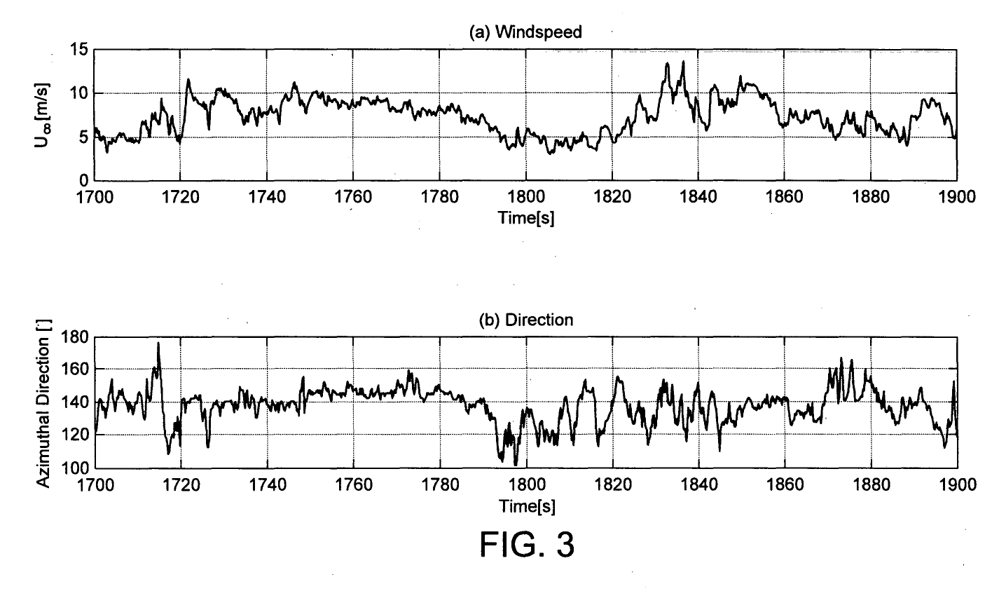

An example of a measured wind sample is shown in FIG. 3. Graph a) shows the variation of wind speed, U, over time during a 200 second snapshot. Graph b) shows the variation in azimuthal direction of the wind during the same time period. As can be seen the wind speed varies greatly. The absolute level varies between 4 m/s and 14 m/s.

The theoretical power per unit of swept area for a wind turbine is given by the equation:

$$\frac{P}{A} = \frac{1}{2} ρ {U}^{3} [ \frac{W}{{m}^{2}} ]$$

It can be seen that the power is related to wind speed by a cubic relationship which, coupled with the data of FIG. 3, shows that there is significantly more energy available in gusty wind conditions than would be suggested by mean wind speed.

For example, during a one hour period, which included the 200 second snapshot of FIG. 3, the mean wind speed measured was 7.6 m/s—implying an available power per swept area of 259 kWhr/m². Summing the power available using the instantaneous wind speeds produces an available power per swept area of 320 kWhr/m²—an increase of 24%.

As a result it is an object of the present invention to provide a wind turbine system which helps to increase the energy output of a wind turbine in gusty conditions without simply relying on the swept area of the turbine.

According to the present invention there is provided a wind turbine system comprising:

a wind turbine;

a regenerative drive system;

a wind-speed sensor for measuring local wind speed; and

a controller;

the wind turbine comprising a motor-generator system which is operatively connected to the regenerative-drive system;

the motor-generator system being drivable as a motor by the regenerative drive system to increase a rotational speed of the wind turbine;

the motor-generator system being operable as a generator by the regenerative drive system to decrease a rotational speed of the wind turbine;

the controller being operatively connected to the wind-speed sensor and the regenerative drive system,

wherein the controller is operable to control operation of the regenerative-drive system to thereby control the rotational speed of the wind turbine in response to signals received from the wind sensor indicative of gusting changes in the local wind speed.

Using a controller to control the rotational speed of the wind turbine dependant on the measured wind speed allows for a greater amount of energy to be extracted from the wind flow by allowing the rotational speed to be matched to the wind speed.

The regenerative drive system may be operable to decrease the rotational speed of the wind turbine by applying a load torque to the motor-generator system. The use of a regenerative drive system allows electrical energy to be input to the wind turbine to increase its rotational speed and also to apply a braking torque to the wind turbine to allow for regenerative braking with the benefit of increased energy output from the turbine at the same time as slowing the rotational speed of the turbine.

Preferably the controller is operable to optimize the rotational speed of the wind turbine for the local wind speed dependent on signals received from the wind-speed sensor.

Preferably the wind-speed sensor is operable to measure the instantaneous wind speed and the controller is operable to optimize the rotational speed of the wind turbine for the measured instantaneous wind speed.

Preferably the controller is operable to alter the rotational speed of the wind turbine dependant on the measured local wind speed in order to maintain a tip speed ratio, λ, of the wind turbine within predetermined limits.

Preferably the wind-speed sensor is operable to measure instantaneous wind speed at a frequency of greater than or equal to two Hertz. More preferably, the wind-speed sensor is operable to measure instantaneous wind speed at a frequency of greater than or equal to four Hertz.

Advantageously, the controller may be operable to alter the rotational speed of the wind turbine at a frequency of up to 1 Hertz. Preferably, the controller is operable to alter the rotational speed of the wind turbine at a frequency of between 0.5 and 1 Hertz.

Preferably, the controller is operable to optimize the rotational speed of the wind turbine such that the energy output of the regenerative drive system is optimized.

Using a controller that allows for adjustments to the rotational speed of the turbine dependant on measured wind speed at a frequency of around 0.5 to 1 Hertz enables the turbine to extract a greater amount of energy from gusting wind conditions. Wind gusts of very short duration—that is fractions of a second—have very little energy contained in them and it therefore inefficient to try and match the rotational speed of the turbine to very short gusts. However, it has been found that adjusting the rotational speed at around 0.5 to 1 Hertz provides a marked increase in the amount of energy extracted.

Preferably the wind turbine is a vertical-axis wind turbine. Also preferably, the vertical-axis wind turbine is a low-inertia wind turbine. Vertical-axis wind turbines have the advantage that they are insensitive to wind direction and are thus able to adjust to gusting winds much more quickly than a horizontal axis wind turbine which must first turn into the wind direction—and it has been found by experiment that gusting winds are usually accompanied by variation in wind direction throughout the gusts. In addition, a wind turbine with a low inertia is able to be accelerated or decelerated by the motor-generator system more quickly. Large conventional turbines that are designed primarily for high mean wind speed conditions often have a large inertia to allow them to continue to rotate—known as coasting—during any temporary lulls in the mean wind speed. Such large inertia turbines are unsuitable for efficiently extracting energy from gusting wind conditions as generally, the frequency at which the rotational speed of a turbine can be adjusted is inversely proportional to the turbine size. Thus, large turbines will typically be less able to extract energy efficiently from high frequency wind gusts.

The motor-generator system comprises a motor and a generator. Preferably the motor and the generator may comprise a single unit. Alternatively the motor and the generator may be separate components which function together as a motor-generator system.

Preferably the motor-generator system comprises a synchronous motor-generator. Preferably the motor-generator system comprises a permanent magnet synchronous motor-generator.

Preferably the regenerative-drive system comprises a four-quadrant regenerative-drive system. Advantageously, the four quadrant regenerative drive is able to supply a positive or negative torque in either positive or negative direction.

The regenerative-drive system is preferably connectable to an external power source.

Preferably the wind-speed sensor comprises an ultrasonic anemometer. An ultrasonic anemometer is able to provide accurate wind speed measurements at a high frequency.

The controller may comprise a computer.

The computer may comprise a microprocessor and memory, wherein the memory comprises processing code for running by the microprocessor for optimizing rotational speed of the wind turbine dependent on the measured local wind speed.

The controller may be separate from the regenerative-drive system. Alternatively, the controller may form a part of the regenerative-drive system.

The present invention also provides a method of controlling a wind turbine system of the type comprising a wind turbine, a motor-generator system, a regenerative drive system, a wind-speed sensor, and a controller, the method comprising the steps of:

operating the controller to receive signals from the wind-speed sensor indicative of the local wind speed;

using the controller to control the regenerative drive system dependant on the received wind-speed signals;

the regenerative drive system controlling the rotational speed of the wind turbine by a combination of operating the motor-generator system as a motor to increase the rotational speed of the wind turbine and operating the motor-generator system as a generator to decrease the rotational speed of the wind turbine;

the controller thereby altering the rotational speed of the wind turbine to adapt to gusting changes in the local wind speed.

The rotational speed of the wind turbine may be decreased by applying a load torque to the motor-generator system.

The wind-speed sensor preferably measures the instantaneous local wind speed.

Preferably the wind-speed sensor measures the instantaneous local wind speed at a frequency of greater than or equal to 2 Hertz. More preferably the wind-speed sensor measures the instantaneous local wind speed at a frequency of greater than or equal to 4 Hertz.

Preferably the controller optimizes the rotational speed of the wind turbine dependent on the measured local wind conditions.

Preferably the controller alters the rotational speed of the wind turbine dependant on the measured local wind speed in order to maintain a tip speed ratio, λ, of the wind turbine within predetermined limits.

Preferably the controller optimizes the rotational speed-of the wind turbine at a frequency of up to 1 Hertz.

More preferably the controller optimizes the rotational speed of the wind turbine at a frequency of between 0.5 and 1 Hertz.

Preferably the regenerative drive system is connected to an external power source and power is supplied to and drawn from the external power source during operation of the regenerative drive system.

Advantageously the controller optimizes the rotational speed of the wind turbine dependent on the local wind conditions to maximize the power supplied to the external power source.

The external power source may be an electricity power transmission grid.

Preferably the wind turbine is a vertical-axis wind turbine.

An embodiment of the present invention will now be described, by way of example only, with reference to the accompanying drawings, in which:

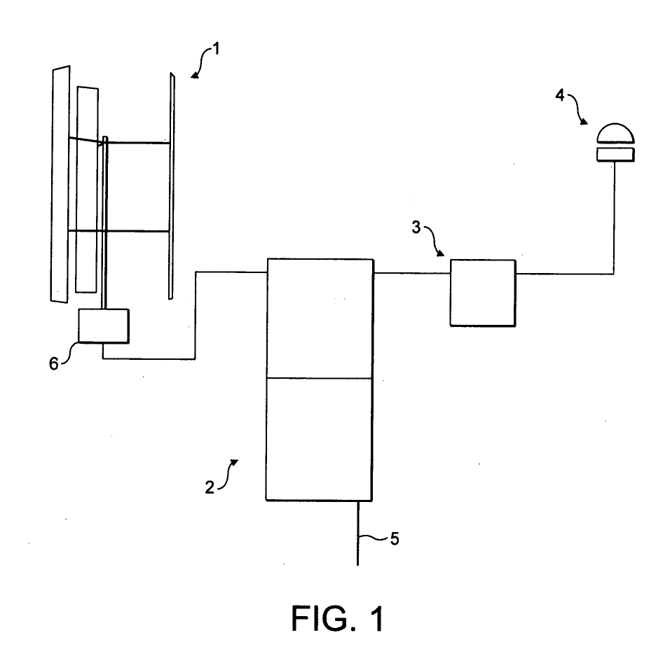

FIG. 1 a schematic representation of a wind turbine system according to the present invention;

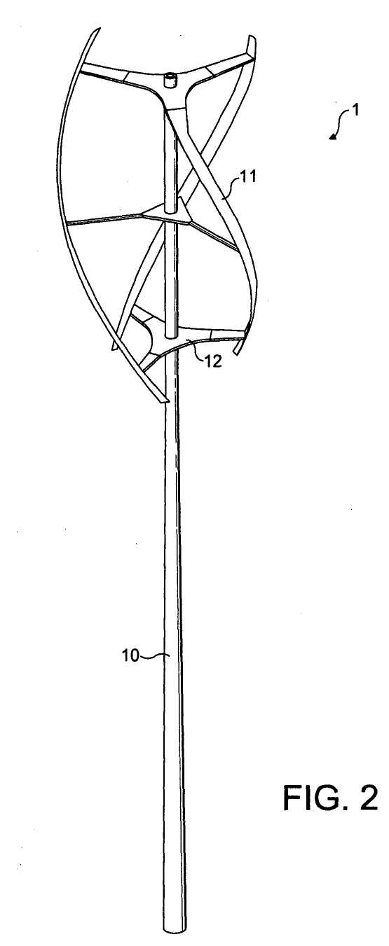

FIG. 2 is a perspective view of a wind turbine for use in the wind turbine system of FIG. 1.

FIG. 3 is a graph of wind speed versus time and of azimuthal wind direction versus time; and

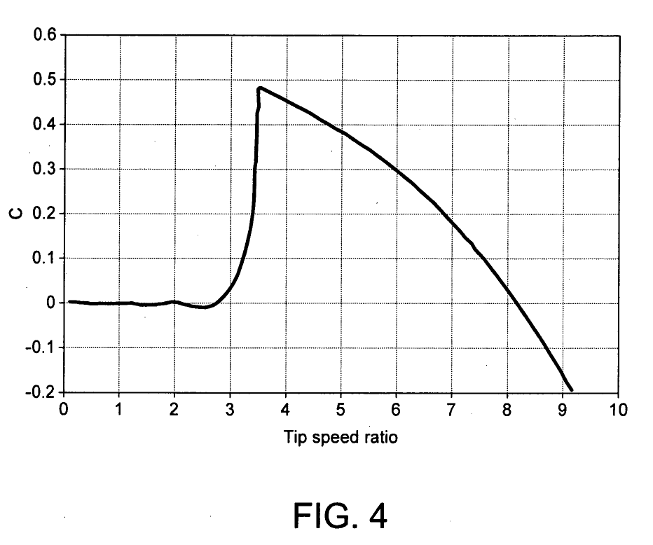

FIG. 4 is a graph showing a Cp power co-efficient curve for the wind turbine of FIG. 2.

As shown in FIG. 1, the wind turbine system comprises a vertical-axis wind turbine 1, a four quadrant regenerative drive 2, a controller 3, an ultrasonic anemometer 4 and a connection to an external electricity power transmission grid 5.

The regenerative drive 2 is connected to the turbine 1, the power grid 5 and the controller 3. The controller 3 is also connected to the anemometer 4.

As shown in FIG. 2, the turbine 1 comprises a shaft 10 on which are mounted three shaped blades 11 by means of struts 12. The design of turbine has a low inertia which is advantageous for the present invention. A suitable vertical-axis wind turbine is described in more detail in GB 2404227. However, the present invention is applicable to other designs of turbine and the detailed design of the turbine will not be described further. The turbine is also provided with a motor-generator in the form of a permanent magnet synchronous motor (PMSM) 6. The PMSM 6 may be formed as part of the turbine 1 or may be a separate unit coupled to the turbine 1 on assembly of the system.

The controller 3 is a computer comprising memory and processing means. The controller 3, in use, receives signals from the anemometer 4 indicative of instantaneous local wind speed and based on its programming sends command signals to the regenerative drive 2 to cause the drive to either increase or decrease the rotational speed of the turbine 1 by use of PMSM 6.

The controller 3 is programmed to attempt, via use of the PMSM 6, to maintain rotational speed of the turbine, and hence the tip speed ratio, λ, of the turbine within pre-set thresholds. For example, as can be seen from FIG. 4 the most efficient energy extraction for the illustrated turbine is achieved at a tip speed ratio of approximately 3.5. Thus, the controller 3 may be programmed to maintain the tip speed ratio at between 3.5 and 4.5 (noting that the tip speed ratio of such turbines typically drops off rapidly at lower tip speed ratios). It should be noted that the Cp curve for each turbine design is different and therefore the actual thresholds programmed into the controller 3 will vary depending on the turbine design.

In use, the turbine 1 will be rotating in the wind flow and thus producing energy via the PMSM 6 which is delivered to the power grid 5 via the regenerative drive connection 2. (Of course, the power produced may be used locally rather than delivered to a power grid). The anemometer 4 measures the instantaneous wind speed at a frequency of 2 to 4 Hertz and this information is sent to the controller 3. The controller 3 calculates the actual tip speed ratio being experienced by the turbine 1 against its preset thresholds. Based on this comparison the controller 3 will either leave the system alone if the tip speed ratio is within the thresholds or alternatively alter the speed of the turbine 1 if the tip speed ratio is outside the thresholds. Accelerating the turbine is achieved by drawing power from the power grid 5 and using the regenerative drive and the PMSM 6 as a motor to drive the turbine to a higher speed. Decelerating the turbine 1 is achieved by using the regenerative drive as a regenerative brake to apply a load torque to the PMSM 6 in order to slow the turbine 1.

Importantly, the adjustment of the rotational speed of the turbine can be achieved several times a second and preferably at a frequency of around 0.5 to 1 Hertz. The ability of the system to rapidly adjust allows it to optimize rotational speed in gusting wind speed conditions where other systems would not be able to take advantage of the extra energy available.

The efficiency of the turbine 1 is therefore increased leading to a higher overall energy output from the turbine 1. This is mainly due to the turbine rotating for a greater period at a more optimal speed for the gusting wind conditions but is also due to the ability to recovery some energy on deceleration of the turbine 1 by regenerative braking.

1. A wind turbine system comprising:
a wind turbine;
a regenerative drive system;
a wind-speed sensor for measuring local wind speed; and
a controller;
the wind turbine comprising a motor-generator system which is operatively connected to the regenerative-drive system;
the motor-generator system being drivable as a motor by the regenerative drive system to increase a rotational speed of the wind turbine;
the motor-generator system being operable as a generator by the regenerative drive system to decrease a rotational speed of the wind turbine;
the controller being operatively connected to the wind-speed sensor and the regenerative drive system,
wherein the controller is operable to control operation of the regenerative-drive system to thereby control the rotational speed of the wind turbine in response to signals received from the wind sensor indicative of gusting changes in the local wind speed.

2. A wind turbine system as claimed in claim 1 wherein the regenerative drive system is operable to decrease the rotational speed of the wind turbine by applying a load torque to the motor-generator system.

3. A wind turbine system as claimed in claim 1 wherein the controller is operable to optimize the rotational speed of the wind turbine for the local wind speed dependent on signals received from the wind-speed sensor.

4. A wind turbine system as claimed in claim 1 wherein the wind-speed sensor is operable to measure the instantaneous wind speed and the controller is operable to optimize the rotational speed of the wind turbine for the measured instantaneous wind speed.

5. A wind turbine system as claimed in claim 1 wherein the controller is operable to alter the rotational speed of the wind turbine dependant on the measured local wind speed in order to maintain a tip speed ratio, λ, of the wind turbine within predetermined limits.

6. A wind turbine system as claimed in claim 4 wherein the wind-speed sensor is operable to measure instantaneous wind speed at a frequency of greater than or equal to two Hertz.

7. (canceled)

8. A wind turbine system as claimed in claim 6 wherein the controller is operable to alter the rotational speed of the wind turbine at a frequency of up to 1 Hertz.

9. (canceled)

10. A wind turbine system as claimed in claim 3 wherein the controller is operable to optimize the rotational speed of the wind turbine such that the energy output of the regenerative drive system is optimized.

11. A wind turbine as claimed in claim 1 wherein the wind turbine is a vertical-axis wind turbine.

12. A wind turbine system as claimed in claim 11 wherein the vertical-axis wind turbine is a low-inertia wind turbine.

13. A wind turbine system as claimed in claim 1 wherein the motor-generator system comprises a motor and a generator, or the motor-generator system comprises a synchronous motor-generator.

14. (canceled)

15. (canceled)

16. (canceled)

17. A wind turbine system as claimed in claim 1 wherein the regenerative-drive system comprises a four-quadrant regenerative-drive system.

18. (canceled)

19. (canceled)

20. A wind turbine system as claimed in claim 1 wherein the controller comprises a computer.

21. (canceled)

22. (canceled)

23. (canceled)

24. A method of controlling a wind turbine system of the type comprising a wind turbine, a motor-generator system, a regenerative drive system, a wind-speed sensor, and a controller, the method comprising the steps of:
operating the controller to receive signals from the wind-speed sensor indicative of the local wind speed;
using the controller to control the regenerative drive system dependant on the received wind-speed signals;
the regenerative drive system controlling the rotational speed of the wind turbine by a combination of operating the motor-generator system as a motor to increase the rotational speed of the wind turbine and operating the motor-generator system as a generator to decrease the rotational speed of the wind turbine;
the controller thereby altering the rotational speed of the wind turbine to adapt to gusting changes in the local wind speed.

25. The method of claim 24 wherein the rotational speed of the wind turbine is decreased by applying a load torque to the motor-generator system.

26. The method of claim 24 wherein the wind-speed sensor measures the instantaneous local wind speed.

27. The method of claim 26 wherein the wind-speed sensor measures the instantaneous local wind speed at a frequency of greater than or equal to 2 Hertz.

28. (canceled)

29. The method of claim 24 wherein the controller optimizes the rotational speed of the wind turbine dependent on the measured local wind conditions.

30. The method of claim 24 wherein the controller alters the rotational speed of the wind turbine dependant on the measured local wind speed in order to maintain a tip speed ratio, λ, of the wind turbine within predetermined limits.

31. The method of claim 29 wherein the controller optimizes the rotational speed of the wind turbine at a frequency of up to 1 Hertz.

32. (canceled)

33. The method of claim 24 wherein the regenerative drive system is connected to an external power source and power is supplied to and drawn from the external power source during operation of the regenerative drive system.

34. The method of claim 33 wherein the controller optimizes the rotational speed of the wind turbine dependent on the local wind conditions to maximize the power supplied to the external power source.

35. (canceled)

36. The method of claim 24 wherein the wind turbine is a vertical-axis wind turbine.
